(19) United States
(12) Patent Application Publication
(10) Pub. No.: US 2008/0069175 A1
(43) Pub. Date: Mar. 20, 2008

(54) Electrode Arm for Arc Furnaces

(75) Inventors: Sven Beermann, Mulheim (DE); Udo Hildebrandt, Essen (DE)

Correspondence Address: BOYLE FREDRICKSON S.C., 840 North Plankinton Avenue, MILWAUKEE, WI, 53203, US

(73) Assignee: Homa Gesellschaft F. Hochstrom-Magnetschalter V. Vollenbroich GmbH & Co. KG, Oberhausen (DE)

(21) Appl. No.: 11/857,088

(22) Filed: Sep. 18, 2007

(30) Foreign Application Priority Data
Sep. 18, 2006 (EP) 06019487.5

(51) Int. Cl. H05B 7/10

(52) U.S. Cl. 373/94

(57) ABSTRACT

The present invention relates to an electrode support arm for arc furnaces comprising an electrode receiving means provided at the front end thereof, the arm comprising a hollow profile which is formed by at least one copper- or aluminum-cladded steel plate. The present invention is based on the problem to provide an electrode support arm satisfying the demands in a better way and having a hollow profile which shows adequate strength and substantially avoids voltage peaks. For solving this problem, the present invention suggests the provision of an electrode arm the hollow profile of which comprises rounded corners.

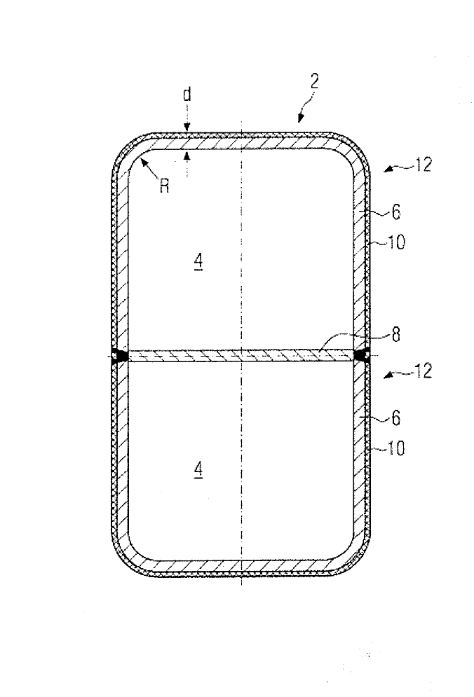

### BACKGROUND OF THE INVENTION

1. Field of the Invention

The present invention relates to an electrode arm for arc furnaces with an electrode receiving means provided at the front end thereof, said arm comprising a hollow profile which is formed by at least one steel plate cladded with copper or aluminum.

2. Description of the Related Art

Electrode support arms for arc furnaces used for steel production serve to hold electrodes, which are normally given a round cross-section and are made from graphite. Said electrodes are held on an electrode receiving means formed by the electrode support arm. This means is normally formed by a clamp that grips the electrode on its circumference, thereby holding the same.

As a rule, an electrode support arm is vertically movable in the longitudinal direction of the electrodes so as to control the penetration depth of the electrode into the arc furnace, thereby influencing the formation of the arc. Particular attention is here paid to a use of the electrodes that is as gentle as possible. However, it may of course happen that for the fusion of scrap the electrodes are impinging at a relatively high speed on the scrap heap located inside the arc furnace. An electrode arm is thus exposed to correspondingly high mechanical loads and must show adequate stiffness and strength, but should be as lightweight as possible to permit a rapid change in penetration depth.

Moreover, very high currents are used at very high voltages in arc furnaces. This entails the problem that electrical arcing may occur between the current-carrying electrode arm and its environment. Moreover, the electrode support arm is cooled because of the thermal load that is also due to power conduction. Apart from the support arm being heated by the flowing current, care must be taken that the electrode support arm is not impermissibly heated because of the thermal conditions prevailing in the arc furnace. As a consequence, cooling ducts extending in the longitudinal direction of the support arm normally extend through electrode support arms. With a corresponding cooling duct, cooling liquid, normally water, is transported from the rear electrode support arm to the front end. At said place the cooling liquid usually cools the contact surfaces for the electrode at the support arm side, said contact surfaces being usually formed by a contact jaw designed in accordance with the contour of the electrode. A clamp clip that is displaceable relative to the support arm is additionally cooled and presses at the side opposite the contact jaw against the electrode, thereby fixing the electrode to the electrode support arm. On account of the relative movability of the clamp clip, the latter is usually supplied via flexible lines with cooling liquid, the lines either starting from the support arm and communicating with the flow ducts formed thereat, or communicating with the source for the cooling liquid, thereby obviating the flow ducts in the electrode support arm.

Due to the high currents the additional problem arises that, on account of the profiled shape of the hollow profile, voltage peaks should be avoided and the electrode support arm should show an electrical resistance as low as possible with respect to the current to be conducted through the support arm.

The complex mechanical, thermal and electrical demands made on the support arm have led to different solution proposals shown in the prior art.

For instance, it has been suggested in U.S. Pat. No. 2,494,775 that the support arm should be made of copper on the whole and configured in a current-conducting manner. The electrode support arm is here made hollow and is provided at the front end with a flange plate forming the contact jaw. Such an electrode support arm does not satisfy the mechanical demands to be made because copper does not show the necessary strength—at least at the weight of a support arm to be tolerated, which amounts to about 4 to 10 tons. Moreover, there is the risk because of the relatively low melting point that copper softens and/or starts to melt at the front end of the electrode support arm when used in the electrode arc furnace.

In an alternative solution suggested in FR-A-1 336 823, the electrode support arm is entirely made from aluminum. Because of the small current load the support arm itself, which is formed as a hollow profile, is not cooled. Tubes which are connected from the outside to the clamp clip and are guided in the further extension inside the hollow profile are provided for the clamp clip of the electrode receiving means.

A support arm of reduced weight in comparison therewith is suggested in EP 0 594 272. This support arm has a hollow profile formed by extruded aluminum. The cooling ducts are here formed inside the aluminum material. The cavity enclosed by the hollow profile is not filled with water and is thus of a reduced weight. Cooling is solely performed via the cooling ducts recessed in the aluminum.

This solution is disadvantageous with respect to the costs entailed by the production process. On the other hand, an electrode support arm made from aluminum might not withstand the mechanical loads and get deformed.

This flaw is remedied with the help of another design principle, which is known from EP-A-0 184 140 and in which the support arm is made from a plurality of flat steel plates that are welded to one another and are cladded on their outside with copper. The intimate connection between steel and copper plates by way of cladding is needed for preventing corrosion, which must otherwise be feared because of the high currents, the presence of cooling water in the hollow profile and the thermal loads caused by the heating and cooling of materials showing a different thermal expansion in the support arm at the phase boundary between the steel plate and the copper plate. Cladding, however, is very troublesome and cost-intensive. Furthermore, precise work is required on the welds of the cladded steel sheets that are normally found in the corners of the profile. For instance, the steel sheet cladded with copper must first be cut off obliquely for welding purposes. Thereupon, the steel plates are welded. The resulting outside of the weld seam must be smoothed. Thereafter, a copper intermediate is provided in the area of the corner of the hollow profile, the intermediate partly covering the steel seam. For continuing the copper cladding of the steel plate a copper weld seam is introduced between the copper intermediate and the cladding. Moreover, a copper weld seam of adequate thickness must be formed at the butt joint of the cladded steel plates that are abutting on each other in the case of a rectangular hollow profile at an angle of 90° C. With an inappropriate design of said weld seams, considerable voltage peaks may arise at the corners of the hollow profiles.

The configuration of copper-cladded steel plates for forming the hollow profile is thus an expensive alternative to the above-mentioned design principles, the alternative being exacting under quality assurance aspects.

The present invention is based on the problem to provide an electrode support arm satisfying the demands in a better way, the hollow profile of the arm showing adequate strength and substantially avoiding voltage peaks.

For the solution of this problem the present invention provides an electrode support arm comprising the features of claim 1. Said electrode support arm develops the support arm known from EP-A-0 184 140, the arm comprising a hollow profile with at least one copper-cladded steel plate. However, the hollow profile according to the invention has rounded corners, rounded corners within the meaning of the present invention preferably standing for those corners in the case of which the ratio of inner radius of curvature to wall thickness of the cladded steel plate is 1.25, preferably 2.25 and more.

### OBJECT OF THE INVENTION

The support arm according to the invention is not limited to a special geometric design of the hollow profile. Different polygonal shapes are for instance possible. Although a rectangular profile with rounded-off corners might be preferred for achieving a design that is as bending-resistant as possible, the electrode support arm may just as well have a polygonal, for instance pentagonal, hexagonal or other polygonal, cross-sectional shape.

It has been found that when the inventive ratio of curvature radius to wall thickness of the cladded steel plate is observed at the corner, voltage peaks can largely be avoided at the corners. The lower limit value suggested for the roundness criterion according to the invention is due to the fact that the cladded steel plate is bent at the corner and that with greater radii the steel plates cannot be bent without impairing the cladding provided at the outside of the steel plate.

The present invention sets a minimal radius of curvature and it is here not ruled out that the rounded-off corner has an irregularly curved extension, the ratio being applicable to the smallest radius of curvature of the rounded-off corner. For simplifying the technical manufacturing process and for achieving current conduction without any loss, if possible, it is however preferred that the radius of curvature is provided as a uniform radius between two neighboring, preferably flat, side surfaces. The ratio of the inner radius of curvature to the wall thickness of the cladded steel plate may here preferably be at least 2.45, particularly preferably at least 2.6.

In a manner known per se, the at least one cladded steel plate forms, on the inside, a cooling duct for the coolant that is cooling the front end of the support arm and diverted into the support arm. Thus the coolant is actually not guided in cooling ducts recessed inside the material forming the hollow profile. Rather, according to the development of the electrode support arm the cavity enclosed by the hollow profile is used for forming the at least one flow duct. Preferably, the hollow profile has at least one partition extending through the profile, the partition subdividing the hollow profile into two compartments of which one compartment forms a flow duct feeding the front end of the electrode support arm, and the other compartment forms the cooling duct for the discharge for the coolant from the front end. The coolant is diverted in the hollow profile at the transition between the one and the other flow duct.

In a simple configuration the hollow profile just forms two cooling ducts, namely by way of a single partition extending through the hollow profile. This partition is preferably formed as a partition wall extending in horizontal direction in the hollow profile and forming underneath thereof the inlet duct for cooling liquid to the front end of the electrode support arm, and the return duct in the upper half.

For accomplishing a manufacturing process that is as simple as possible it is suggested according to a further preferred design of the present invention that the hollow profile should be formed by two identical or at last substantially identical half profiles that are interconnected as bent half shells, preferably by welding. The half profiles consist each of a single steel plate cladded with copper or aluminum.

A further simplification of the manufacturing process is accomplished when the partition is welded together with the half profiles. The partition is preferably also made from steel. The steel plates (without cladding) may enclose the partition thereinbetween, or they may directly abut on each other and be welded together. In this instance, the partition is sealed on the inner circumferential surface of the hollow profile. At the weld joint a copper filler may then be welded to the joint in a per se known manner for completing the aluminum or copper skin of the support arm. It is also possible to entirely dispense at the joint of the half profiles with an outer Cu or Al cladding completed by welding.

To prevent corrosion by coolant flowing in the hollow profile and for distributing the flow in an optimum way over the circumference of the hollow profile, it is suggested according to a further preferred embodiment of the present invention that the inside of the hollow profile should be formed over the whole circumference by the steel material, and the outside of the hollow profile should be formed over the whole circumference by the cladding of copper or aluminum.

Further details and advantages of the present invention become apparent from the following description of an embodiment taken in conjunction with the drawing, which is a cross-sectional view through a hollow profile.

### BRIEF DESCRIPTION OF THE DRAWING

The hollow profile 2 shown in the drawing is normally formed in the longitudinal direction of the electrode support arm without any defects and continuously from the rear end thereof up to a clamp device for clamping the clamp clip, namely in such a manner that two cooling ducts 4 are formed in the interior of the hollow profile 2. Said cooling ducts 4 are surrounded on the circumference by the material of steel plates 6, 8. The steel plate 8 is provided as a flat straight steel sheet in the interior of the hollow profile 2 and connects opposing flat outer surfaces of the (cladded) steel plates provided with a cladding (10) (here of copper).

### DETAILED DESCRIPTION OF THE PREFERRED EMBODIMENT

The cladding 10 provided on the outside of the hollow profile 2 extends substantially over the whole outer circumferential surface of the hollow profile 2. It is just in the middle of the hollow profile 2, there at the place where two bent half shells 12 forming the hollow profile 2 and made from the cladded steel plates 6 abut on each other and are welded together, that copper fillers have been welded thereonto for completing the copper cladding 10.

The corners of the hollow profile 2 are round and have an inner radius of curvature R of about 68 millimeters, whereas the wall thickness d of the cladded steel plate 6, i.e. steel plate 6 with cladding 20, is approximately 30 millimeters.

1. An electrode support arm for arc furnaces, the electrode support arm having an electrode receiver at a front end thereof and comprising: a hollow profile which is formed by at least one copper- or aluminum-cladded steel plate,
wherein the hollow profile comprises rounded corners.

2. The electrode support arm according to claim 1, wherein the rounded corners have a ratio of inner radius of curvature (R) to wall thickness (d) of the cladded steel plates of at least 1.25.

3. The electrode support arm according to claim 1, wherein the cladded steel plates form, on the inside, a cooling duct for a coolant that cools the front end of the support arm and that is diverted in the support arm.

4. The electrode support arm according to claim 3, wherein two cooling ducts are formed by a partition extending through the hollow profile.

5. The electrode support arm according to claim 4, wherein the hollow profile is formed by two identical half profiles of steel plates cladded with copper or aluminum.

6. The electrode support arm according to claim 5, wherein the half profiles are welded together at the level of the partition.

7. The electrode support arm according to claim 1, wherein the inside of the hollow profile is formed over the whole circumference thereof by the steel material, and the outside of the hollow profile is formed over the whole circumference by the copper or aluminum cladded thereonto.

8. The electrode support arm according to claim 1, wherein the rounded corners have a ratio of inner radius of curvature (R) to wall thickness (d) of the cladded steel plates of at least 2.25.
